(19) United States
(12) Patent Application Publication
(10) Pub. No.: US 2014/0236715 A1
(43) Pub. Date: Aug. 21, 2014

(54) TARGETED ADVERTISING IN SOCIAL MEDIA NETWORKS

(71) Applicant: KENSHOO LTD., Tel Aviv, IL (US)

(72) Inventors: Michael Aronowich, Haifa (IL); Arriel Johan Benis, Rehovot (IL); Reut Yanai, Tel Aviv (IL)

(73) Assignee: KENSHOO LTD., Tel Aviv, IL (US)

(21) Appl. No.: 14/036,494

(22) Filed: Sep. 25, 2013

Related U.S. Application Data
(60) Provisional application No. 61/766,812, filed on Feb. 20, 2013.

(51) Int. Cl. G06Q 30/02; G06Q 50/00

(52) U.S. Cl. CPC G06Q 30/0254; G06Q 50/01
USPC 705/14.52

(57) ABSTRACT

Machines, systems and methods for managing reach of an advertisement campaign, the method comprising selecting an initial seed of one or more keywords, such that the initial seed is pertinent to a target audience with known interests and demographics; receiving at least one candidate keyword to be added to the initial seed; determining effectiveness of the candidate keyword based on relevancy, expansion and redundancy parameters associated with the candidate keyword; and expanding the initial seed by adding the candidate keyword, in response to determining that the candidate keyword meets a threshold measure for effectiveness.

### CROSS-REFERENCE TO RELATED APPLICATIONS

Pursuant to 35 USC 119, this application claims the right of priority to Provisional Patent Application Ser. No. 61/766,812 filed on Feb. 20, 2013. The content of said application is incorporated herein by reference in entirety.

### COPYRIGHT & TRADEMARK NOTICES

A portion of the disclosure of this patent document may contain material, which is subject to copyright protection. The owner has no objection to the facsimile reproduction by any one of the patent document or the patent disclosure, as it appears in the Patent and Trademark Office patent file or records, but otherwise reserves all copyrights whatsoever.

Certain marks referenced herein may be common law or registered trademarks of the applicant, the assignee or third parties affiliated or unaffiliated with the applicant or the assignee. Use of these marks is for providing an enabling disclosure by way of example and shall not be construed to exclusively limit the scope of the disclosed subject matter to material associated with such marks.

### TECHNICAL FIELD

The disclosed subject matter relates generally to targeted advertising and, more particularly, to the optimal selection of keywords that may be used to target a certain group in a network of people with known interests and demographics.

### BACKGROUND

Digital social media networks such as Facebook™ provide advertisers with the option to select keywords to target members of the social media network that the advertisers feel are best-suited for certain advertisements. In other words, the selected keywords help expose particular ads to a target audience based on an identified association between the selected keywords and particular members of the social media network. As such, selecting the proper keywords is important because the quality of an advertising campaign is directly correlated with the relevance of the selected keywords to the advertisement topic.

Advertising managers in a digital social media network strive to expand the audience of their advertisement campaign, while keeping the reach of the advertisement campaign focused. Certain factors such as the geographic location of the social media members, their demographics and sociological attributes, in addition to an understanding of the members' individual or collective interests are often relevant to planning an advertising campaign for a certain product, and the combination of those factors will determine the reach of the advertisement campaign. An understanding of how such factors are selected to better promote the product can be very helpful to successfully advertise over a social media network.

Due to evolving trends in a social media network, a member's interests (e.g., Facebook® “like” feature) and the keywords associated with these interests may change frequently, sometimes hourly, daily or weekly. The trends may be related to online or offline events, seasonal behavior in the commercial world and other social changes affecting the interests of the social media network members. Therefore, in order to create a successful advertisement campaign over the social media network, a set of keywords, which represent a part of the member's interests, is selected by a human operator (e.g., an advertising manager) who should understand the nature of the changes and the trending interests in the particular social media network.

If the keywords are not properly selected, the targeted audience may be irrelevant to a topic of interest associated with the ad, or in some cases, the targeted audience may not be sufficiently relevant to a specific interest (e.g., too large). Furthermore, if the keyword audience is too large in the initial target audience, the expansion will not be focused. Social media network's tools (e.g., Facebook's precise interest targeting tool) may be used to better determine the keywords that are more relevant. Learning how to properly use such tools, however, is time and labor-consuming and requires substantial human analysis and an expert level of understanding for the tool to be used in a meaningful way.

Moreover, a human operator may not be able to timely respond to changes of interests in a social media network as such changes are in large scale and can happen very quickly, therefore may not be readily visible to the human operator as those changes take place. It is desirable to have an automated and efficient method for expanding the targeted audience in advertising platforms for a social media network, by both expanding the size of the audience and, at the same time, focusing the reach of the advertisement to the most relevant audience.

### SUMMARY

For purposes of summarizing, certain aspects, advantages, and novel features have been described herein. It is to be understood that not all such advantages may be achieved in accordance with any one particular embodiment. Thus, the disclosed subject matter may be embodied or carried out in a manner that achieves or optimizes one advantage or group of advantages without achieving all advantages as may be taught or suggested herein.

In accordance with one embodiment, machines, systems and methods for targeted advertising are provided. The method comprises selecting an initial seed of one or more keywords, such that the initial seed is pertinent to a target audience with known interests and demographics; receiving at least one candidate keyword to be added to the initial seed; determining effectiveness of the candidate keyword based on relevancy, expansion and redundancy parameters associated with the candidate keyword; and expanding the initial seed by adding the candidate keyword, in response to determining that the candidate keyword meets a threshold measure for effectiveness.

In accordance with one or more embodiments, a system comprising one or more logic units is provided. The one or more logic units are configured to perform the functions and operations associated with the above-disclosed methods. In yet another embodiment, a computer program product comprising a computer readable storage medium having a computer readable program is provided. The computer readable program when executed on a computer causes the computer to perform the functions and operations associated with the above-disclosed methods.

One or more of the above-disclosed embodiments in addition to certain alternatives are provided in further detail below with reference to the attached figures. The disclosed subject matter is not, however, limited to any particular embodiment disclosed.

### BRIEF DESCRIPTION OF THE DRAWINGS

The disclosed embodiments may be better understood by referring to the figures in the attached drawings, as provided below.

FIG. 1A is a diagram illustrating target, initial keywords, and seed concepts utilized to generate a new list of keywords in accordance with one embodiment.

FIG. 1B is a diagram illustrating an expansion metric utilized to generate a new list of keywords in accordance with one embodiment.

FIG. 1C is a diagram illustrating a relevancy metric utilized to generate a suitable new list of keywords in accordance with one embodiment.

FIG. 1D is a diagram illustrating a redundancy metric utilized to generate a new list of keywords in accordance with one embodiment.

FIG. 2 is a flow diagram of an example method for generating a suitable list of keywords for the purpose of promoting content to a target audience in a social media network, in accordance with one embodiment.

FIG. 3 is a diagram illustrating an example seed expansion scenario, in accordance with one embodiment.

FIGS. 4A through 4D are diagrams illustrating an example scenario for the targeted expansion method and process in accordance with one embodiment.

FIGS. 5A and 5B are block diagrams of hardware and software environments in which the disclosed systems and methods may operate, in accordance with one or more embodiments.

Features, elements, and aspects that are referenced by the same numerals in different figures represent the same, equivalent, or similar features, elements, or aspects, in accordance with one or more embodiments.

### DETAILED DESCRIPTION OF EXAMPLE EMBODIMENTS

In the following, numerous specific details are set forth to provide a thorough description of various embodiments. Certain embodiments may be practiced without these specific details or with some variations in detail. In some instances, certain features are described in less detail so as not to obscure other aspects. The level of detail associated with each of the elements or features should not be construed to qualify the novelty or importance of one feature over the others.

In accordance with one embodiment, systems and methods are provided to select, in an optimized manner, keywords that may be used to target a certain group in a network of individuals with known interests and demographics (e.g., members of a digital social media network). Desirably, selecting the proper keywords results in the most pertinent audience being reached for the purpose of dissemination of content (e.g., promotional ads), with an optimized balance between several factors including relevancy, expansion and redundancy, as provided in further detail below.

When designing an advertisement campaign for social media advertising, an advertising campaign manager (e.g., a human operator) may use analysis tools, either independently or as provided by a social media network service provider (e.g., Facebook®, Twitter®, LinkedIn®) to design an advertisement campaign that is directed to a targeted audience with specific interests and falling within particular social demographics groups. The specific interests of the social media members and their demographic profiles may be tracked based on the social media members interaction with the social media pages in which the members provide demographic information (e.g., age, gender, locality, country, area, city, occupation, etc.) as well as information about what is interesting to the members (e.g., membership in a group, interest in a product or person, etc.).

The advertising campaign manager may interact with a user interface of a decision support system to enter certain data and parameters in order to generate a set of keywords useful for promoting an advertisement to a targeted group of members in the social media network. The data entered by the advertising campaign manager may, without limitation, comprise:
(1) a set of seed keywords relevant to at least one topic of interest for an ad,
(2) conditions that define the target audience (e.g., demographics and connections' of a social media member), and
(3) constraints limiting the number of suggested keywords (i.e., candidate keywords), such as:
   a. the size of the target audience,
   b. the budget allocated to the campaign,
   c. process specific constraints.

In response to the above input, based on the seed keywords, an additional set of keywords (e.g., suggested/candidate keywords) is received from the social media service provider, either manually or by way of other sources. In one embodiment, additional candidate keywords are suggested that are relevant to the targeted demographic and related to the seed. The size of the targeted audience for the seed keywords and the additional keywords may be retrieved from the social advertising platform, such that, for example, size S1 reflects the number of members in the social media network that are associated with the identified demographics and also members that are interested by topics defined by the seed keywords (e.g., the size of the audience who has “liked” pages related to the seed keywords).

Once the list of candidate keywords is suggested, one or more of the candidate keywords in the list may be selected to be added to the original seed to generate an updated seed. As such, the updated seed after the addition of the one or more candidate keywords would include a set of interest keywords that include the newly added one or more candidate keywords that consequently may alter the designated targeted audience (or size of S1).

In accordance with one example embodiment, the seed keywords (e.g., keywords in the original seed set) as pertaining to a designated targeted audience are filtered and expanded, according to certain criteria, to select the most relevant keywords and to expand the seed in an efficient way. Once one or more predefined constraints are met, the process of expanding the seed is stopped. Otherwise, the process is continued to generate additional keywords based on a new set of keywords until the constraints are met.

To better understand the features and process covered by this disclosure, without limitation and by way of example, one or more embodiments are provided in additional detail below. Such additional details should not be construed as limiting the general scope of the claimed subject matter to the particular examples. As such, the following definitions are provided to better understand such detailed embodiments without detracting from the scope of the claimed subject matter:
(1) API: Application Programming Interface. Protocol used as an interface by software components to communicate with others.
(2) Targeting: allows defining a target using a set of constraints, such as demography, sociology, economic, social network(s) connection(s) and others.
(3) Target: the type of user/users which an advertisement will be displayed to (can be referred to as “target audience”).
(4) Keyword (KW): a set including at least one word (taking into account definitions of a few Social Networks (e.g., Facebook, Twitter, LinkedIn).
(5) Initial Keywords or Seed: a set including at least one keyword used to target a specific target audience which their interests are associated with those keywords. For example, in the “Precise Interests” tool of Facebook (also known as “Likes and Interests” suggestions tool), the seed is the list of keywords initially provided by the advertiser manager to the tool. Using the method claimed here, the seed may automatically and intelligently expended.
(6) Audience: a number of members in the social media network who are likely to see an ad.
(7) Data provider: a service providing gross lists of related keywords, or likes and interests (e.g., Facebook, Twitter, Zemanta for Wordpress, etc.).
(8) Likes and Interests: a list of keywords which have been defined as improving the audience of an ad.
(9) Potential suggestion: for example, a “Precise Interests” (in Facebook) suggestion provided by a data provider.
(10) Negative Likes and Interests: a list of keywords which have been defined as having a negative impact on the focused expansion; said keywords are detected and automatically excluded (without any additional computational process).
(11) Expanded seed: the combination of Target, Initial Keywords (or Seed), and the system “Likes and Interests” suggestions.
(12) Expansion: the number of individuals increasing the target audience.
(13) Relevancy: numbers of users interested in the seed keywords and a suggested keyword.
(14) Redundancy: a factor reflecting the general popularity of a keyword for an audience as will be further detailed below.
(15) Composite Quality Index (CQI): a factor reflecting the quality of a suggested keyword in order to both increase a target audience and keep it focused. The Quality Index defines a measure for the effectiveness of a candidate keyword.
(16) Minimal support thresholds: Values defined for the relevancy, the expansion, the redundancy and the composite quality index. These thresholds defined the relative minimal numbers of a social network' users related to each one of said factors.
(17) Maximal support thresholds: Values defined for the relevancy, the expansion, the redundancy and the composite quality index. These thresholds defined the relative maximal numbers of a social network' users related to each one of said factors.
(18) Number of runs or number of iterations: Numbers of maximal times that the expansion process is run for expanding a seed.

In accordance with one example embodiment, separate factors may be calculated to help determine the effectiveness of one or more candidate keywords (designating an interest) as part of the process that will be detailed below. It is noteworthy that throughout this disclosure the terms “candidate keyword”, “potential keyword” or “suggested keyword” are used interchangeably and refer to a keyword that has the potential for expanding the seed depending on whether the keyword can efficiently expand the reach of a respective advertisement campaign, according to factors that include: relevancy, expansion and redundancy as provided in further detail below.

Relevancy factor: The relevancy of a new keyword is determined by calculating the intersection between the audience (i.e., social media network members) related to a set of interest keywords (i.e., the seed) and the audience related to the new keyword. The relevancy factor for a keyword provides a measure for the number of users, which are associated both with the seed as well as with the new keyword. Mathematically the relevancy factor represents the joint number of individuals in the audience of a seed (S) and in the audience of a potential suggestion (K), relative to the audience of S. The larger the relevancy metric is, the more commonality exists between seed (S) and potential suggestion (K), a desirable property for a potential suggestion to a certain extent.

$$Relevancy = \frac{\vert S ⋂ K \vert}{\vert S \vert} \times 100$$

Expansion Factor: An expansion factor for a keyword may be measured based on the increase in the number of individuals added to the audience of the seed. As such, the expansion factor provides an indication of the rate by which the size of the target audience is enlarged by the addition of the new keyword to the seed. Mathematically, the expansion factor may be calculated as the relative number of individuals added to the audience of a seed (S) when a potential suggestion (K) is added to the seed. The larger this metric is, the more efficiency a potential suggestion (K) exhibits, in that a larger audience is being joined to the suggestion.

$$Expansion = \frac{\vert S ⋃ K \vert - \vert S \vert}{\vert S \vert} \times 100$$

Redundancy Factor: A redundancy factor may be determined based on the overlap in reaching the overall audience related to demographics constraints identified for an advertisement campaign, and the audience of the new keyword. Thus, the redundancy factor provides a measure of understanding the general popularity of the new keyword. Mathematically, the redundancy factor is a metric indicating the overlap (e.g., in percentage) between the target audience (T) and the target audience of a candidate keyword K. The redundancy factor indicates the general popularity of a candidate keyword (K). If the popularity measure for a keyword is higher than a threshold, it may indicate that the target audience is not adequately focused.

$$Redundancy = \frac{\vert T ⋂ K \vert}{\vert T \vert} \times 100$$

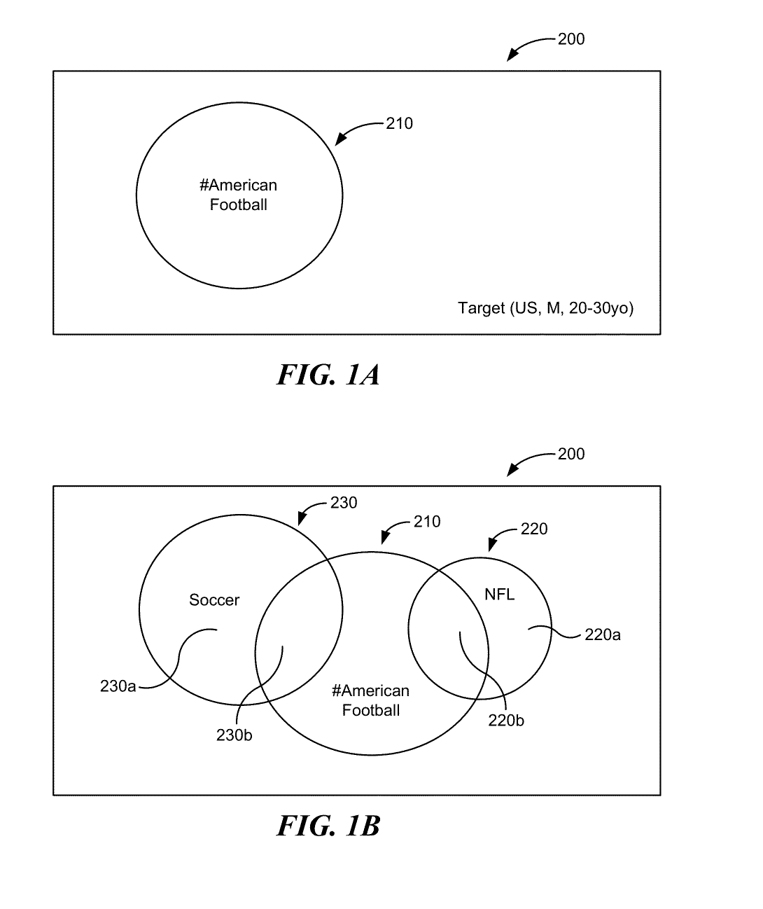

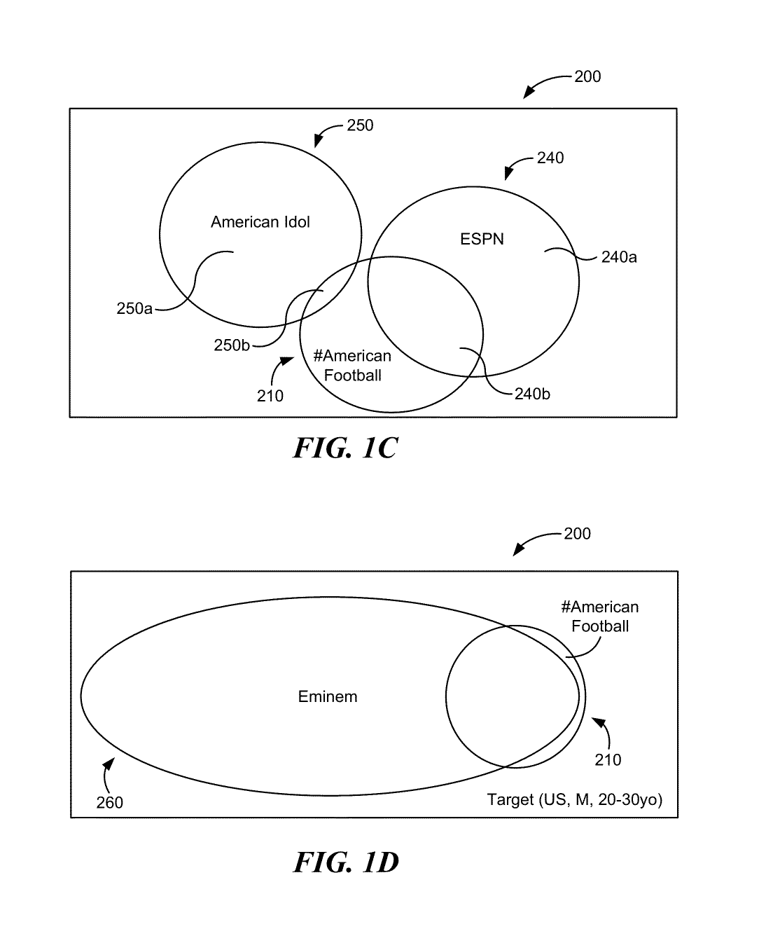

FIGS. 1A through 1D illustrate the definitions of seed, target, expansion, relevancy and redundancy, using exemplary values for keywords and target audience. FIG. 1A shows a target audience 200 related to “M (male), aged between 20 and 30 years old, located in US”. The initial related seed audience 210 is provided based on a seed including the keyword “#American football”. In FIG. 1B, keywords NFL 220 and Soccer 230 are the suggested candidate keywords having the same relevancy values (220b, 230b) relative to the current seed 210, but having different expansion values (220a, 230a) relative to the same current seed 210. As shown, the keyword “Soccer” 230 expands the seed audience 210 more than “NFL” 220.

Referring to FIG. 1C, the keywords “ESPN” 240 and “American Idol” 250 are suggested candidate keywords having the same expansion values (240a, 250a) relative to the current seed 210, but having different relevancy values (240b, 250b) relative to the same current seed 210. As shown, the keyword “ESPN” 240 is more relevant to the seed audience 210 than “American Idol” 250, in this example. In FIG. 1D, the keyword “Eminem” 260 is a popular keyword and is highly relevant to in the target audience 200. This is determined to be a highly redundant keyword. Furthermore, the audience associated with the keyword “Eminem” 260 has a very large (e.g., too large) overlap with the audience for the seed 210 and also has a very high expansion value. Thus, the keyword “Eminem” 260 may be deemed as too popular and not useful for providing a focused expansion according to the scope of the present invention.

In one embodiment, the updated seed represents the conjunction of the keywords in the seed and one or more of the candidate keywords derived from the seed. It is noteworthy that the candidate keywords are selected in a manner that promotes relevance and expansion and limits redundancy in the audience that is associated with the seed (or the updated seed). In more detail, the candidate keywords are selected such that the audience associated with the seed (or the updated seed) is related to one or more keywords included in the seed (or the updated seed). In one implementation, the candidate keywords may overlap with one or more keywords in the seed (i.e., the keywords may be associated with the same social media members) or may be added to the seed in such a way to allow for the maximization of relevance and expansion, and the minimization of redundancy among the audience that is reached by the combination of the seed keywords and the candidate keywords. The addition of the candidate keywords to the seed may continue in several iterations, until a certain condition is met.

In one example, when a suggested candidate keyword for inclusion in the updated seed is received from the social advertising platform or data provider, the audience size, reflecting the number of members associated with the conjunction of the seed keywords and the candidate keyword is also received. Hereafter, we refer to the keyword set that includes the conjunction of the seed keywords and the candidate keyword as the candidate updated seed. The knowledge of the numbers that reflect the size of audience associated with the seed and the candidate updated seed is used to determine whether a threshold condition is met for the seed to be updated to include the candidate keyword.

The threshold condition may be determined based on the relevancy and expansion factors. For example, if the relationship between calculated relevancy and expansion for the selected keywords is determined to meet predetermined criteria, then the seed may be updated to include one or more candidate keywords and to generate an updated seed. The updated seed may be then designated as the seed, and the process indicated above may be repeated to update the seed one or more times until one or more conditions or constraints are met. As a part of the selection process, before a derived candidate keyword is added to the seed, the candidate keyword may be checked individually against the original seed to determine whether the result remain relevant to the original seed.

A keyword that has been suggested in an iteration (e.g., during the previous run) and has not been added to the updated seed, may appear in a future set of suggested keywords and be added to the seed if relevancy, expansion and redundancy metrics meet defined constraints (e.g., if the metrics fall within acceptable value ranges). As noted, the above process may continue until a set of conditions or constraints are met. The conditions or constraints and the ranges may be set to define the target audience based on demographics or socioeconomic parameters. The constraints may, for example, define the approximate size of the audience, targeted ages, occupations, etc.

Accordingly, online social advertising systems that apply keyword selection based on empirical data concerning likes and interests of members of the social media networks may be optimized. The system thus increases efficiency by allowing both automation and real-time adjustments to current trends, for example, and includes a method which optimally balances between several factors in determining the optimal keyword list for the desired digital campaign.

In one example, the system analyzes the suggested keywords' reach, the audiences of the seed, and the suggested keywords, and determines the index value of the updated seed, as provided in further detail below. In an exemplary embodiment, the output may be a list of keywords ranked by a quality index, which gives the largest, yet most relevant audience that will be exposed to ads. Such list of keywords may be further utilized in social-oriented advertisement systems.

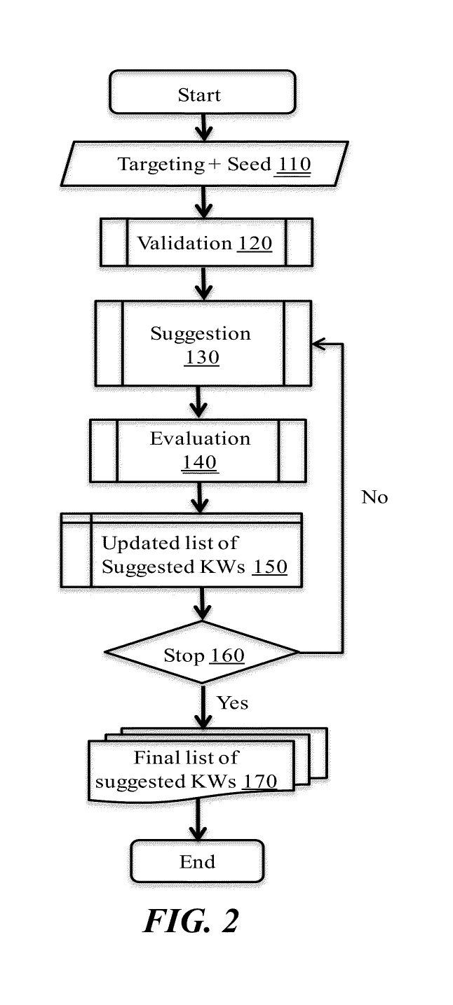

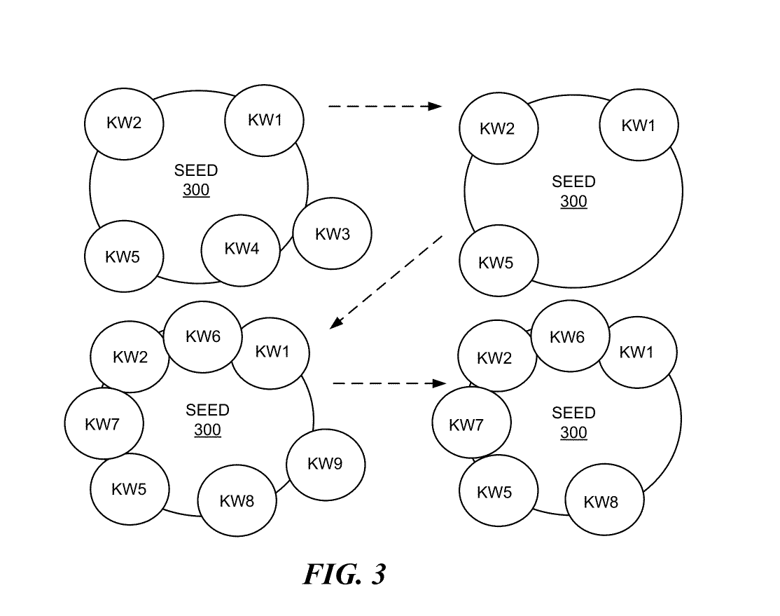

A detailed description of an exemplary embodiment is provided below, with reference to FIG. 2, which illustrated a flow diagram of an example method for generating a suitable list of keywords for effectively targeting relevant audience in accordance with one embodiment of the invention. In this example, a human operator (e.g., an advertisement campaign manager) may provide information including targeting data (e.g., demographics, geography, etc.) and one or more seed keywords that are to be delivered to a social media advertisement platform, for example, by way an application programming interface (API) (110). Optionally, the human operator may additionally or alternatively provide one or more negative keywords which will be excluded from the expansion process. These keywords may be related, for example, to a commercial competitor or to an old product.

In one implementation, a validation module may be utilized to validate the provided input against predetermined objective criteria to determine whether a reasonable reach for the targeted audience is achieved (120) following initial feedback received from the social advertising platform. For example, if the objective is to reach an audience of about 100,000 and the feedback provided by the social media service provider indicates that the audience size for the targeting data and the seed keywords is about a 1000, or about 1,000,000, then the entered information may be adjusted to reach an audience that is closer to the intended objective.

A suggestion module may be utilized to translate the input data by the human operator to an initial list of keywords or interests and communicate the input data or the initial list to a network advertising platforms. In one implementation, an API may be provided that translates the data provided by a human operator to an initial list of keywords or interests. Utilizing the suggestion module, a potential suggestion for keywords to be added to the set of seed keywords is received (130). Receiving the suggestion of related keywords may be from the social network adverting platform (e.g. Facebook Marketplace®) via an API, for example.

The generated list of potential keywords as suggested by the suggestion module may be evaluated and analyzed against evaluation criteria (140), including parameters referred to earlier (e.g., relevancy, expansion, and redundancy) to, for example, generate a CQI, in accordance with one or more embodiments. Optionally, and if negative keywords are provided, during the evaluation a suggestion of related keywords from the social network advertising platforms may be compared with a list of negative keywords. If the negative keyword appears in the list, the keyword is automatically excluded from the expansion process without additional computation.

In one implementation, relevancy, expansion and redundancy metrics may be evaluated for each of the suggested keywords and a CQI may be generated according to the following formula:

$$C Q I = \frac{log ( E ) + log ( R )}{log ( T )} \times \frac{min ( log ( E ) , log ( R ) )}{max ( log ( E ) , log ( R ) )} \times \frac{1}{log ( Red )}$$

This CQI value, besides assigning a calculable weight to the absolute values of the expansion and relevancy, may be configured to favor a relative symmetry between the expansion and relevancy metrics. In other words, CQI reflects the quality of a suggested keyword in order to both increase a target audience and keep it focused.

In response to determining that an objective is reached or that certain constraints are met (e.g., the target audience is at least 500,000 and no greater than 1,000,000, and the daily amount to spend is not higher than $300), a decision is made whether or not to stop expanding the seed (160). This is also referred to as a ‘stop criteria’. If a decision is made not to expand the seed any further, then a final list of suggested keywords may be generated (170).

Referring to FIG. 3, an exemplary illustration of a seed expansion scenario in accordance with one or more embodiments is provided. In this example, it is presumed that a target audience is defined based on selected demographics, sociological parameters and constraints in order to reach a relevant audience of a certain size, in response to user input, where a seed 300 is to be built based on a list of suggested keywords KW1, KW2, KW3, KW4 and KW5. For the keywords, evaluation criteria (e.g., relevancy, expansion, redundancy, and possibly CQI) may be computed according to the example formulas noted above. Referring to the diagram in the upper-right corner of FIG. 3, a subset of keywords (e.g., KW1, KW2 and KW5) may be selected to be included in the seed where the selected keywords are selected based on the maximization of relevance and expansion, and minimization of redundancy among the audience that is reached by the combination of the keywords. Not meeting a stop criteria (process 160 in FIG. 2), the updated list (e.g., KW1, KW2 and KW5) may be set as input for generating additional suggested keywords (running process 130 on FIG. 2 again).

Referring to the diagram in the lower-left corner of FIG. 3, newly suggested keywords (KW6, KW7, KW8 and KW9) may be provided as additional candidate keywords to be added to the seed 300. Evaluation of KW6, KW7 and KW8 in this second iteration may indicate that addition of said keywords would maximize relevance and expansion and minimize redundancy among the audience that is reached by the combination of the keywords in the seed. If so, said keywords are added to seed 300 as shown in the lower-right corner of the FIG. 3.

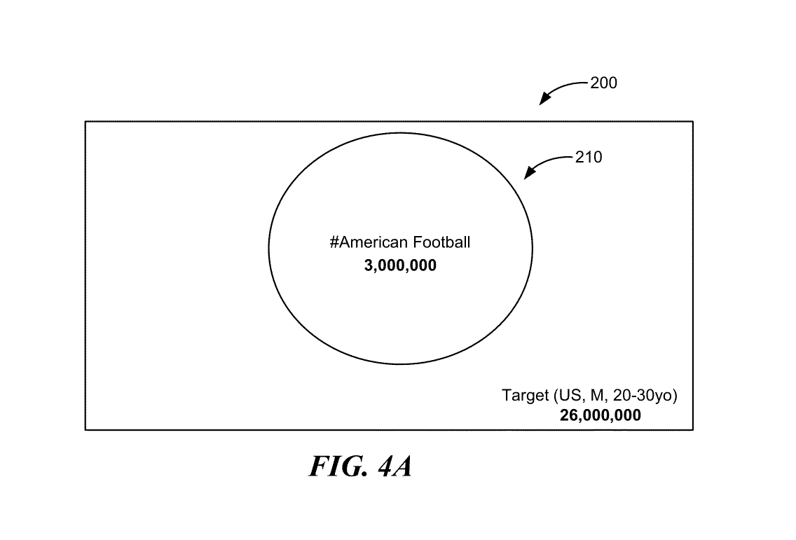

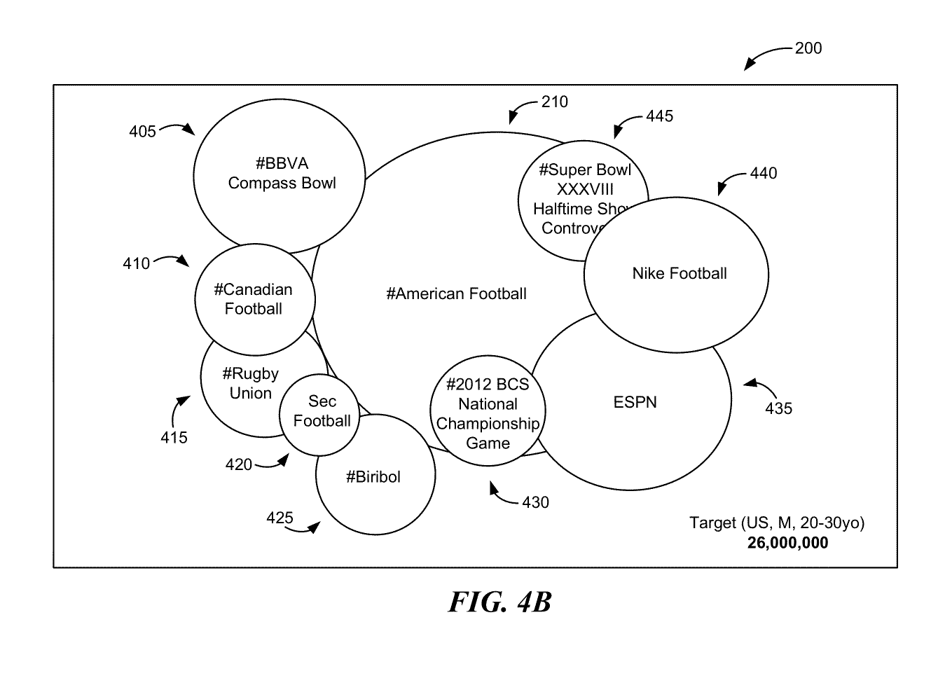

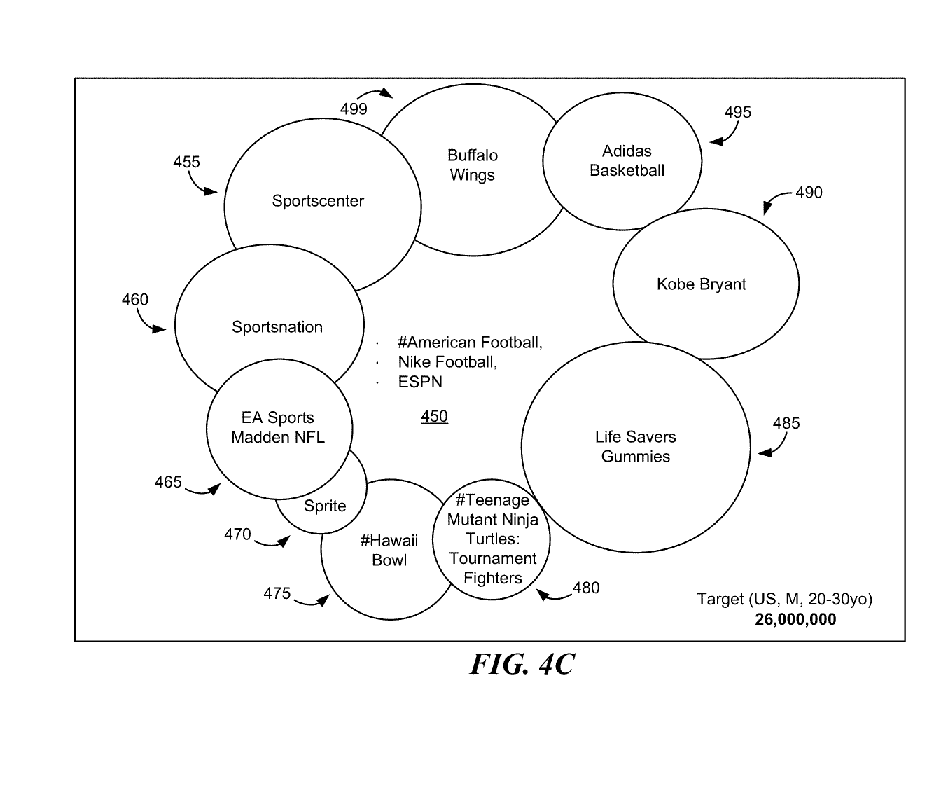

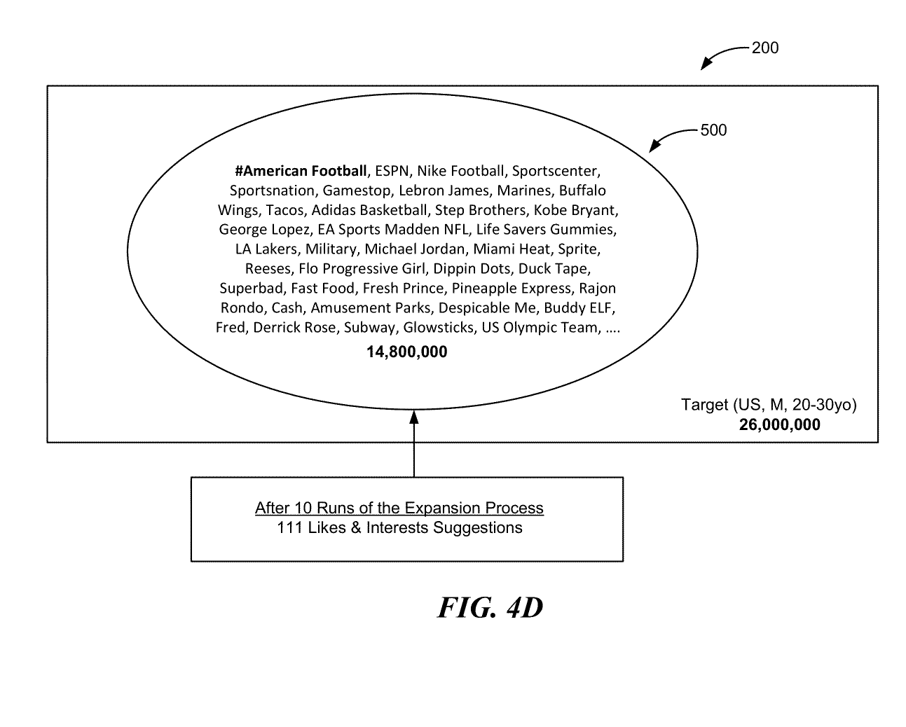

Referring to FIGS. 4A though 4D, an example is provided that illustrates an audience expansion process according to the method illustrated in FIG. 2. As shown, an advertising campaign manager may want to reach a target audience 200 defined by “M (male), aged between 20 and 30 years old, located in US” which corresponds to an audience of 26,000,000 social media network members. As shown, based on an initial seed 210 that includes the keyword “#American football” an audience of 3,000,000 social media network members may be targeted.

Referring to FIG. 4B, the expansion process during a first run may be initiated by a set of keywords (405, 410, 415, 420, 425, 430, 435, 440, 445), where the relevancy, expansion, and redundancy factors are computed in order to calculate the CQI for one or more of said keywords (see evaluation process 140 in FIG. 2). For example, according to the relevancy, expansion and redundancy factors of the suggested keywords, “espn” (435) and “nike football” (440) may be selected by the expansion process at this first run.

Referring to FIG. 4C, the seed 210 may be updated to include the following: “#American football”, “espn”, “nike football” (see update process 150 in FIG. 2). During a second expansion run (where no stop criteria have been met) a new set of keywords may be suggested by the social network advertising platform. For the newly suggested keywords (455, 460, 465, 470, 475, 480, 485, 490, 495, 499) the relevancy, expansion, and redundancy factors as well as the CQI are computed. According to the CQI values keywords 455, 460, 465, 485, 490, 495 and 499 may be selected by the expansion targeting process and the seed may be updated.

In an example scenario, after three evaluation iterations involving the process selecting candidate keywords to update the seed as provided above, the updated seed may include following keywords: “#American Football”, “Nike football”, “espn”, “ea sports madden nfl”, “sportsnation”, “sportscenter”, “buffalo wings”, “Adidas basketball”, “kobe Bryant” and “life savers gummies”. The related targeted audience (A3) for those keywords may be 8,800,000.

During a fourth iteration of the expansion process, the candidate keywords suggested by the social advertising platform provider may be those disclosed in column KW of Table 1 below. In order to determine which candidate keywords, as suggested in the new iteration, may be added to the updated seed, the following values may be computed, in accordance with one implementation: relevancy, expansion and CQI. Below is an example table with results presented in percentages.

TABLE 1

| run | KW | Relevancy | Expansion | Redundancy | CQI |
|---|---|---|---|---|---|
| 4 | adidas basketball | 4 | 6.67 | 1.2308 | 1.6717 |
| 4 | tubing | 7.3333 | 6.67 | 1.6154 | 1.4814 |
| 4 | dwight howard | 9.3333 | 6.67 | 1.8462 | 1.3486 |
| 4 | boston red sox | 4 | 13.33 | 2 | 1.1888 |
| 4 | new england patriots | 6.6667 | 13.33 | 2.3077 | 1.1631 |
| 4 | last day school | 10.6667 | 13.33 | 2.7692 | 1.1094 |
| 4 | kevin durant | 10.6667 | 13.33 | 2.7692 | 1.1094 |
| 4 | chocolate chip | 15.3333 | 13.33 | 3.3077 | 1.0291 |
| | cookies | | | | |
| 4 | dane cook | 8 | 20.00 | 3.2308 | 0.97145 |
| 4 | chicago bulls | 10 | 20.00 | 3.4615 | 0.96211 |
| 4 | trey songz | 14.6667 | 20.00 | 4 | 0.93476 |
| 4 | rob dyrdek | 16 | 20.00 | 4.1538 | 0.92668 |
| 4 | kid cudi | 15.3333 | 40.00 | 6.3846 | 0.73776 |
| 4 | nicki minaj | 17.3333 | 40.00 | 6.6154 | 0.73673 |
| 4 | ti | 24 | 40.00 | 7.3846 | 0.72942 |
| 4 | drake | 33.3333 | 66.67 | 11.5385 | 0.62468 |
| 4 | basketball | 40 | 86.67 | 14.6154 | 0.58102 |

According to an example keyword selection process, a CQI may be generated based on the relevancy, expansion, and redundancy metrics. Based on the computed CQI and selection keywords having a particular CQI (e.g., CQI>1 as defined by the human operator), the following keywords may be added to the seed to get S4: “adidas basketball”, “tubing”, “Dwight howard”, “boston red sox”, “new england patriots”, “last day school”, “kevin durant”, “chocolate chip cookies”. As such, after the seed S3 is updated, an updated seed S4 is generated and would include the following set of keywords: “#American Football, Nike football, espn, ea sports madden nfl, sportsnation, sportscenter, buffalo wings, Adidas basketball, kobe bryant, life savers gummies, adidas basketball, tubing, dwight howard, boston red sox, new england patriots, last day school, kevin durant, chocolate chip cookies.” According to the social advertising platform, for this example, the related audience (A4) equals to 12,000,000.

FIG. 4D shows an example of expansion targeting after 10 runs of the process and the possible end result (following a stop criteria having been met—e.g. the audience target size constraint, the maximum number of expansion process runs). For example, 111 keywords may have been suggested, allowing targeting an audience of 14,800,000 social media network members over the 26,000,000 in the initial target range 200. This means that the audience targeting has been multiplied by 5 since the first expansion targeting process based on target (200) and the initial seed (210). The CQI values of each keyword may be used to sort the keywords selected during the expansion process. Optionally, keywords having a too low CQI value may be excluded as the low scoring keywords may not efficiently impact the target audience.

References in this specification to “an embodiment”, “one embodiment”, “one or more embodiments” or the like, mean that the particular element, feature, structure or characteristic being described is included in at least one embodiment of the disclosed subject matter. Occurrences of such phrases in this specification should not be particularly construed as referring to the same embodiment, nor should such phrases be interpreted as referring to embodiments that are mutually exclusive with respect to the discussed features or elements.

In different embodiments, the claimed subject matter may be implemented as a combination of both hardware and software elements, or alternatively either entirely in the form of hardware or entirely in the form of software. Further, computing systems and program software disclosed herein may comprise a controlled computing environment that may be presented in terms of hardware components or logic code executed to perform methods and processes that achieve the results contemplated herein. Said methods and processes, when performed by a general purpose computing system or machine, convert the general purpose machine to a specific purpose machine

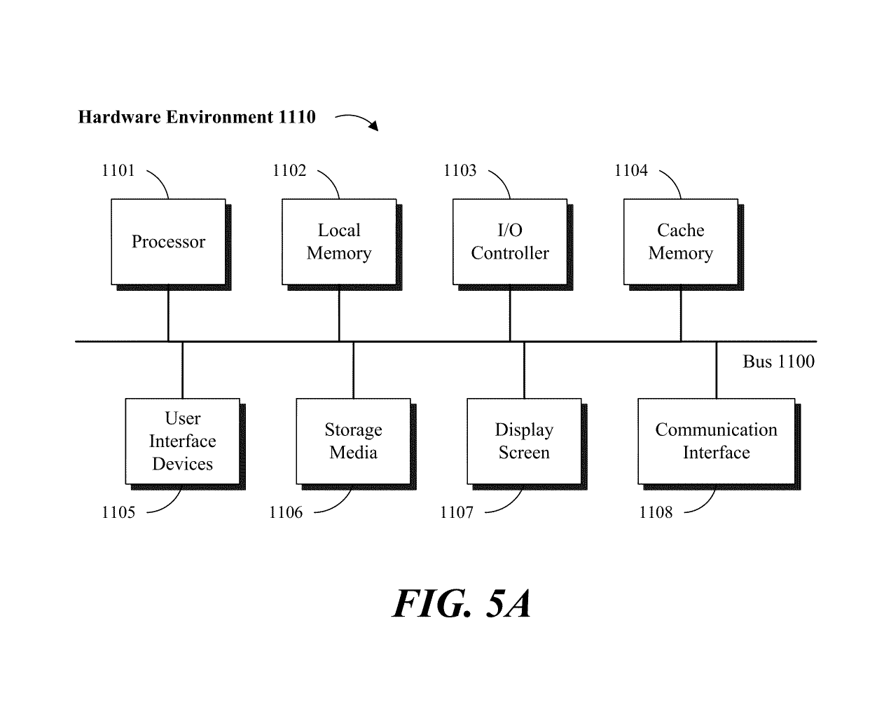

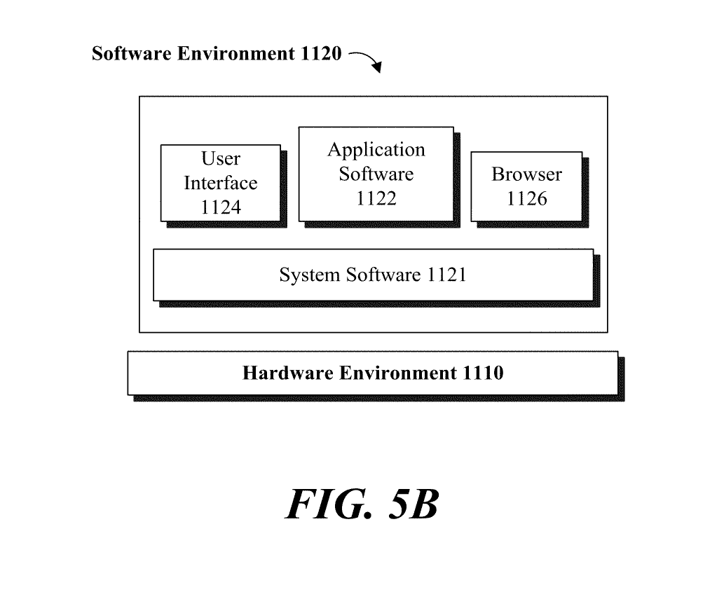

Referring to FIGS. 5A and 5B, a computing system environment in accordance with an exemplary embodiment may be composed of a hardware environment 1110 and a software environment 1120. The hardware environment 1110 may comprise logic units, circuits or other machinery and equipments that provide an execution environment for the components of software environment 1120. In turn, the software environment 1120 may provide the execution instructions, including the underlying operational settings and configurations, for the various components of hardware environment 1110.

Referring to FIG. 5A, the application software and logic code disclosed herein may be implemented in the form of machine readable code executed over one or more computing systems represented by the exemplary hardware environment 1110. As illustrated, hardware environment 110 may comprise a processor 1101 coupled to one or more storage elements by way of a system bus 1100. The storage elements, for example, may comprise local memory 1102, storage media 1106, cache memory 1104 or other machine-usable or computer readable media. Within the context of this disclosure, a machine usable or computer readable storage medium may include any recordable article that may be utilized to contain, store, communicate, propagate or transport program code.

A computer readable storage medium may be an electronic, magnetic, optical, electromagnetic, infrared, or semiconductor medium, system, apparatus or device. The computer readable storage medium may also be implemented in a propagation medium, without limitation, to the extent that such implementation is deemed statutory subject matter. Examples of a computer readable storage medium may include a semiconductor or solid-state memory, magnetic tape, a removable computer diskette, a random access memory (RAM), a read-only memory (ROM), a rigid magnetic disk, an optical disk, or a carrier wave, where appropriate. Current examples of optical disks include compact disk, read only memory (CD-ROM), compact disk read/write (CD-R/W), digital video disk (DVD), high definition video disk (HD-DVD) or Blue-ray™ disk.

In one embodiment, processor 1101 loads executable code from storage media 1106 to local memory 1102. Cache memory 1104 optimizes processing time by providing temporary storage that helps reduce the number of times code is loaded for execution. One or more user interface devices 1105 (e.g., keyboard, pointing device, etc.) and a display screen 1107 may be coupled to the other elements in the hardware environment 1110 either directly or through an intervening I/O controller 1103, for example. A communication interface unit 1108, such as a network adapter, may be provided to enable the hardware environment 1110 to communicate with local or remotely located computing systems, printers and storage devices via intervening private or public networks (e.g., the Internet). Wired or wireless modems and Ethernet cards are a few of the exemplary types of network adapters.

It is noteworthy that hardware environment 1110, in certain implementations, may not include some or all the above components, or may comprise additional components to provide supplemental functionality or utility. Depending on the contemplated use and configuration, hardware environment 1110 may be a machine such as a desktop or a laptop computer, or other computing device optionally embodied in an embedded system such as a set-top box, a personal digital assistant (PDA), a personal media player, a mobile communication unit (e.g., a wireless phone), or other similar hardware platforms that have information processing or data storage capabilities.

In some embodiments, communication interface 1108 acts as a data communication port to provide means of communication with one or more computing systems by sending and receiving digital, electrical, electromagnetic or optical signals that carry analog or digital data streams representing various types of information, including program code. The communication may be established by way of a local or a remote network, or alternatively by way of transmission over the air or other medium, including without limitation propagation over a carrier wave.

As provided here, the disclosed software elements that are executed on the illustrated hardware elements are defined according to logical or functional relationships that are exemplary in nature. It should be noted, however, that the respective methods that are implemented by way of said exemplary software elements may be also encoded in said hardware elements by way of configured and programmed processors, application specific integrated circuits (ASICs), field programmable gate arrays (FPGAs) and digital signal processors (DSPs), for example.

Referring to FIG. 4B, software environment 1120 may be generally divided into two classes comprising system software 1121 and application software 1122 as executed on one or more hardware environments 1110. In one embodiment, the methods and processes disclosed here may be implemented as system software 1121, application software 1122, or a combination thereof. System software 1121 may comprise control programs, such as an operating system (OS) or an information management system, that instruct one or more processors 1101 (e.g., microcontrollers) in the hardware environment 1110 on how to function and process information. Application software 1122 may comprise but is not limited to program code, data structures, firmware, resident software, microcode or any other form of information or routine that may be read, analyzed or executed by a processor 1101.

In other words, application software 1122 may be implemented as program code embedded in a computer program product in form of a machine-usable or computer readable storage medium that provides program code for use by, or in connection with, a machine, a computer or any instruction execution system. Moreover, application software 1122 may comprise one or more computer programs that are executed on top of system software 1121 after being loaded from storage media 1106 into local memory 1102. In a client-server architecture, application software 1122 may comprise client software and server software. For example, in one embodiment, client software may be executed on a client computing system that is distinct and separable from a server computing system on which server software is executed.

Software environment 1120 may also comprise browser software 1126 for accessing data available over local or remote computing networks. Further, software environment 1120 may comprise a user interface 1124 (e.g., a graphical user interface (GUI)) for receiving user commands and data. It is worthy to repeat that the hardware and software architectures and environments described above are for purposes of example. As such, one or more embodiments may be implemented over any type of system architecture, functional or logical platform or processing environment.

It should also be understood that the logic code, programs, modules, processes, methods and the order in which the respective processes of each method are performed are purely exemplary. Depending on implementation, the processes or any underlying sub-processes and methods may be performed in any order or concurrently, unless indicated otherwise in the present disclosure. Further, unless stated otherwise with specificity, the definition of logic code within the context of this disclosure is not related or limited to any particular programming language, and may comprise one or more modules that may be executed on one or more processors in distributed, non-distributed, single or multiprocessing environments.

As will be appreciated by one skilled in the art, a software embodiment may include firmware, resident software, micro-code, etc. Certain components including software or hardware or combining software and hardware aspects may generally be referred to herein as a “circuit,” “module” or “system.” Furthermore, the subject matter disclosed may be implemented as a computer program product embodied in one or more computer readable storage medium(s) having computer readable program code embodied thereon. Any combination of one or more computer readable storage medium(s) may be utilized. The computer readable storage medium may be a computer readable signal medium or a computer readable storage medium. A computer readable storage medium may be, for example, but not limited to, an electronic, magnetic, optical, electromagnetic, infrared, or semiconductor system, apparatus, or device, or any suitable combination of the foregoing.

In the context of this document, a computer readable storage medium may be any tangible medium that can contain, or store a program for use by or in connection with an instruction execution system, apparatus, or device. A computer readable signal medium may include a propagated data signal with computer readable program code embodied therein, for example, in baseband or as part of a carrier wave. Such a propagated signal may take any of a variety of forms, including, but not limited to, electro-magnetic, optical, or any suitable combination thereof. A computer readable signal medium may be any computer readable medium that is not a computer readable storage medium and that can communicate, propagate, or transport a program for use by or in connection with an instruction execution system, apparatus, or device.

Program code embodied on a computer readable storage medium may be transmitted using any appropriate medium, including but not limited to wireless, wireline, optical fiber cable, RF, etc., or any suitable combination of the foregoing. Computer program code for carrying out the disclosed operations may be written in any combination of one or more programming languages, including an object oriented programming language such as Java, Smalltalk, C++ or the like and conventional procedural programming languages, such as the “C” programming language or similar programming languages.

The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

Certain embodiments are disclosed with reference to flowchart illustrations or block diagrams of methods, apparatus (systems) and computer program products according to embodiments. It will be understood that each block of the flowchart illustrations or block diagrams, and combinations of blocks in the flowchart illustrations and/or block diagrams, can be implemented by computer program instructions. These computer program instructions may be provided to a processor of a general purpose computer, a special purpose machinery, or other programmable data processing apparatus to produce a machine, such that the instructions, which execute via the processor of the computer or other programmable data processing apparatus, create means for implementing the functions or acts specified in the flowchart or block diagram block or blocks.

These computer program instructions may also be stored in a computer readable storage medium that can direct a computer, other programmable data processing apparatus, or other devices to function in a particular manner, such that the instructions stored in the computer readable storage medium produce an article of manufacture including instructions which implement the function or act specified in the flowchart or block diagram block or blocks.

The computer program instructions may also be loaded onto a computer, other programmable data processing apparatus, or other devices to cause a series of operational steps to be performed on the computer, other programmable apparatus or other devices to produce a computer or machine implemented process such that the instructions which execute on the computer or other programmable apparatus provide processes for implementing the functions or acts specified in the flowchart or block diagram block or blocks.

The flowchart and block diagrams in the figures illustrate the architecture, functionality, and operation of possible implementations of systems, methods and computer program products according to various embodiments. In this regard, each block in the flowchart or block diagrams may represent a module, segment, or portion of code, which comprises one or more executable instructions for implementing the specified logical functions. It should also be noted that, in some alternative implementations, the functions noted in the block may occur in any order or out of the order noted in the figures.

For example, two blocks shown in succession may, in fact, be executed substantially concurrently, or the blocks may sometimes be executed in the reverse order, depending upon the functionality involved. It will also be noted that each block of the block diagrams or flowchart illustration, and combinations of blocks in the block diagrams or flowchart illustration, may be implemented by special purpose hardware-based systems that perform the specified functions or acts, or combinations of special purpose hardware and computer instructions.

The claimed subject matter has been provided here with reference to one or more features or embodiments. Those skilled in the art will recognize and appreciate that, despite of the detailed nature of the exemplary embodiments provided here, changes and modifications may be applied to said embodiments without limiting or departing from the generally intended scope. These and various other adaptations and combinations of the embodiments provided here are within the scope of the disclosed subject matter as defined by the claims and their full set of equivalents.

What is claimed is:

1. A method for managing reach of an advertisement campaign, the method comprising:
selecting an initial seed of one or more keywords, such that the initial seed is pertinent to a target audience with known interests and demographics;
receiving at least one candidate keyword to be added to the initial seed;
determining effectiveness of the candidate keyword in reaching the target audience based on relevancy, expansion and redundancy parameters associated with the candidate keyword; and
expanding the initial seed by adding the candidate keyword, in response to determining that the candidate keyword meets a threshold measure for effectiveness.

2. The method of claim 1, wherein the target audience includes members of a social media network.

3. The method of claim 1, wherein the candidate keyword is selected based on known interests and demographics for the target audience to facilitate communication of most pertinent content to the target audience.

4. The method of claim 1, wherein the candidate keyword is selected for expanding the initial seed based on a quality index calculated for the candidate keyword, wherein the quality index defines a measure for the effectiveness of the candidate keyword and is calculated based on the relevancy, expansion and redundancy parameters associated with the candidate keyword.

5. The method of claim 1, wherein the initial seed is expanded until it is determined that a predetermine stop criteria is met.

6. The method of claim 1, further comprising forwarding the expanded seed to a digital advertising platform.

7. The method of claim 1, wherein a relevancy parameter associated with a candidate keyword (K) represents joint number of individuals in audience of a seed (S) and in audience of K, relative to the audience of S.

8. The method of claim 1, wherein an expansion parameter associated with a candidate keyword (K) represents the relative number of individuals added to audience of the seed (S) when K is added to the S.

9. The method of claim 1, wherein a redundancy parameter associated with a candidate keyword (K) represents the relative overlap between a suggested potential audience in a target (T) for K and the suggested potential audience for the seed (S).

10. The method of claim 1, wherein a relevancy parameter associated with a candidate keyword (K) represents the joint number of individuals in audience of the seed (S) and in audience of K, relative to the audience of S, such that:
$$Relevancy = \frac{\vert S ⋂ K \vert}{\vert S \vert} \times 100 ,$$
wherein an expansion parameter associated with K represents the relative number of individuals added to the audience of S when K is added to the S, such that:
$$Expansion = \frac{\vert S ⋃ K \vert - \vert S \vert}{\vert S \vert} \times 100 ,$$
wherein a redundancy parameter associated with K represents the relative overlap between a suggested potential audience in a target (T) for K and the suggested potential audience for S, such that:
$$Redundancy = \frac{\vert T ⋂ K \vert}{\vert T \vert} \times 100 ,$$
and
wherein the relevancy, expansion and redundancy parameters are evaluated for K to generate an index value (CQI) according to the following formula:
$$C Q I = \frac{log ( E ) + log ( R )}{log ( T )} \times \frac{min ( log ( E ) , log ( R ) )}{max ( log ( E ) , log ( R ) )} \times \frac{1}{log ( Red )} .$$

11. A system for managing reach of an advertisement campaign, the system comprising:
a logic unit for selecting an initial seed of one or more keywords, such that the initial seed is pertinent to a target audience with known interests and demographics;
a logic unit for receiving at least one candidate keyword to be added to the initial seed;
a logic unit for determining effectiveness of the candidate keyword based on relevancy, expansion and redundancy parameters associated with the candidate keyword; and
a logic unit for expanding the initial seed by adding the candidate keyword, in response to determining that the candidate keyword meets a threshold measure for effectiveness.

12. The system of claim 11, wherein the target audience includes members of a social media network.

13. The system of claim 11, wherein the candidate keyword is selected based on known interests and demographics for the target audience to facilitate communication of most pertinent content to the target audience.

14. The system of claim 11, wherein the candidate keyword is selected for expanding the initial seed based on a quality index calculated for the candidate keyword, wherein the quality index defines a measure for the effectiveness of the candidate keyword and is calculated based on the relevancy, expansion and redundancy parameters associated with the candidate keyword.

15. The system of claim 11, wherein the initial seed is expanded until it is determined that a predetermine stop criteria is met, the system further comprising a logic unit for forwarding the expanded seed to a digital advertising platform.

16. A computer program product for managing reach of an advertisement campaign, the computer program product comprising logic code embedded in a non-transitory data storage medium, wherein execution of the logic code on at least one computing processor causes the processor to:
select an initial seed of one or more keywords, such that the initial seed is pertinent to a target audience with known interests and demographics;
receive at least one candidate keyword to be added to the initial seed;
determine effectiveness of the candidate keyword based on relevancy, expansion and redundancy parameters associated with the candidate keyword; and
expand the initial seed by adding the candidate keyword, in response to determining that the candidate keyword meets a threshold measure for effectiveness.

17. The computer program product of claim 16, wherein the target audience includes members of a social media network.

18. The computer program product of claim 16, wherein the candidate keyword is selected based on known interests and demographics for the target audience to facilitate communication of most pertinent content to the target audience.

19. The computer program product of claim 16, wherein the candidate keyword is selected for expanding the initial seed based on a quality index calculated for the candidate keyword, wherein the quality index defines a measure for the effectiveness of the candidate keyword and is calculated based on the relevancy, expansion and redundancy parameters associated with the candidate keyword.

20. The computer program product of claim 16, wherein the initial seed is expanded until it is determined that a predetermine stop criteria is met, and wherein the expanded seed is forwarded to a digital advertising platform.
